(19) United States
(12) Patent Application Publication
(10) Pub. No.: US 2016/0140232 A1
(43) Pub. Date: May 19, 2016

(54) System and Method of Expanding a Search Query

(71) Applicant: Radialpoint Safecare Inc., Montreal (CA)

(72) Inventors: Alexis Smirnov, Brossard (CA); Pablo Ariel Duboue, Montreal (CA)

(21) Appl. No.: 14/546,419

(22) Filed: Nov. 18, 2014

(51) Int. Cl. G06F 17/30

(52) U.S. Cl. CPC G06F 17/30864; G06F 17/3097

(57) ABSTRACT

A method and apparatus is provided for expanding a search query that fails to full specify an information need. When a current search query from a user is received, a set of candidate search query patterns are identified based on the keywords in the search query. One or more missing components in the candidate patterns are identified. The search query is expanded to include keywords corresponding at least one of the missing components in one of the candidate search query patterns.

### TECHNICAL FIELD

The present disclosure relates generally to information search and retrieval technologies and, more particularly, to technologies for implicit collaborative searching based on a search history database.

### BACKGROUND

Customer support agents typically relay on a knowledgebase to provide solutions to technical support problems. However, knowledgebases frequently contain gaps in knowledge and do not provide an answer to every technical support problem. When a solution to a technical support problem is not found in the knowledgebase, customer support agents may conduct searches on the Internet to find a solution.

Discovering solutions to technical support problems on the Internet can be time consuming. Most Internet search engines are not designed to surface solutions to technical support problems. Rather, rankings are usually based on the linking structure of web pages, which does not necessarily surface the most relevant results. Also, search queries entered by customer support agents may fail to fully describe the information need and return results that are not pertinent to the problem. Therefore, agents must spend a lot of time reviewing and filtering the search results to find web pages that provide a solution to a particular technical support problem. The efforts of one technical support agent may subsequently duplicated by another technical support agent that is presented with the same technical support problem.

### SUMMARY

The present disclosure relates to collaborative search techniques that enable customer support agents to quickly find solutions to technical support problems and to recommend web pages providing solutions to technical support problems to other persons in the technical support community. The present disclosure also provides insight to knowledgebase managers on gaps in the knowledge base and new content to fill the gaps. The main elements of the collaborative search system comprise a client-side utility that installs into a web browser used by a technical support agent, a database server that stores a history of searches conducted by customer support agents, and an analytics engine to analyze searches conducted by customer support agents.

The browser utility is an application that installs as a browser extension. The browser utility captures search information as customer support agents perform Internet searches. The captured information includes search queries entered by the technical support agent, clicks on search results, and timestamps for search queries and clicks. In addition, the browser utility adds a button on the toolbar of the browser that allows agents to recommend any web pages that the agent finds helpful in finding a solution to a technical support problem. All data collected by the browser utility is sent in real time to the database server.

The database server maintains a search history database that stores the search queries performed by customer support agents along with web pages recommended by the customer support agents. When a technical support agent performs a search, the browser utility sends the search query to the database server. The database server compares the received search query to searches stored in the search history database. If the search history database contains a previous search that is sufficiently similar to the current search query, the database server outputs recommended web pages associated with the matching search queries to the browser utility. The browser utility then displays the recommended web pages to the agent in the browser window along with the conventional search results.

The analytics service provides analytics for web searches conducted by the customer support agents. Information provided by the analytics service includes usage trends (e.g., aggregate number of searches performed per day), average search time, query trends (e.g., aggregate statistics for most frequent searches); most visited web sites, and list of suggested or recommended web pages with corresponding search queries. The list of recommended web pages is derived from web pages flagged by customer support agents.

According to another aspect of the disclosure, a technique is provided of expanding a search query entered by a customer support agent that fails to fully specify the information need. Where the information need is not fully specified, the keywords entered by the customer support agent may be compared to a predefined set of query patterns. These query patterns comprises components that correspond to different ontological classes. If the search query fails to fully describe the information need, the query expansion function may identify a set of candidate patterns based the keywords in the search query and prompt the user to either enter additional keywords corresponding to the class of the missing component or to select from a set of candidate queries that more fully describe the information need.

According to another aspect of the disclosure, a technique is provided of naming a query cluster. Queries in the search history database representing the same information need may be grouped into query clusters. Using a domain ontology, a set of templates may be defined that describe the typical patterns followed by search queries. Each pattern comprises a set of components that correspond to the classes defined by the domain ontology. The templates may be pre-defined by a knowledge base manager or machine generated. Cluster names are generated by mapping the most relevant keywords in a query cluster to corresponding components in a selected one of the naming templates.

### BRIEF DESCRIPTION OF THE DRAWINGS

FIG. 1 illustrates the main functional elements of a collaborative search system according to one exemplary embodiment.

FIG. 2 illustrates an exemplary process for performing a search, capturing search information, and providing a list of recommended web pages.

FIG. 3 illustrates a browser window displaying exemplary search results page for a conventional web search.

FIG. 4 illustrates a browser window displaying an exemplary search results page with recommended web pages highlighted.

FIG. 5 illustrates a browser window displaying an exemplary search results page with recommend web pages in a separate list along with the conventional results.

FIG. 6 illustrates an exemplary process for browsing web sites returned by a search and recommending web pages.

FIG. 7 illustrates a browser window with an interactive control for recommending web pages.

FIG. 8 illustrates an exemplary dialog box for entering the name of an agent making a recommendation.

FIG. 9 illustrates an exemplary database structure for the search history database.

FIG. 10 illustrates an exemplary record set for the history table in search history database.

FIG. 11 illustrates an exemplary method implemented by the database server for searching and updating the search history database.

FIG. 12 illustrates an exemplary database server.

FIG. 13 illustrates an exemplary knowledge domain ontology for technical support.

FIG. 14 illustrates an exemplary method of naming a query cluster using a knowledge domain ontology.

FIGS. 15A-15F illustrates use of a naming template for naming query clusters.

FIG. 16 illustrates an exemplary data analysis server.

FIG. 17 illustrates an exemplary method of expanding a search query using a knowledge domain ontology.

FIG. 18 illustrates another exemplary method of expanding a search query using a knowledge domain ontology.

### DETAILED DESCRIPTION

Referring now to the drawings, a collaborative search system 10 according exemplary embodiment is shown. The collaborative search system 10 is designed to complement technical support knowledgebases that may be used by customer support agents. However, knowledgebases frequently contain gaps in knowledge and do not provide an answer to every technical support problem. When a solution to a technical support problem is not found in the knowledgebase, customer support agents may conduct searches on the Internet to find a solution. The collaborative search system 10 enables customer support agents to more quickly find solutions to technical support problems and to recommend web pages providing solutions to those technical support problems to other persons in the technical support community. The collaborative search system 10 also collects information providing insight to knowledge base managers regarding gaps in a technical support knowledgebase.

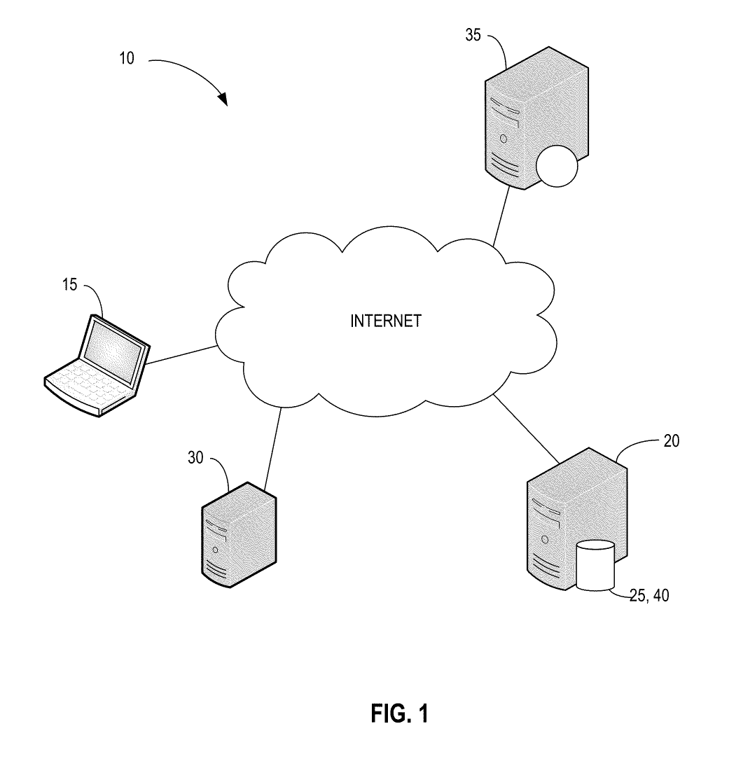

Referring to FIG. 1, the main functional components of the collaborative search system 10 comprises a browser utility 15 that installs as an extension into a web browser used by a technical support person, a database server 20 that stores a record of searches conducted by technical support persons and web pages browsed by the technical support agent in a search history database 25, and an analytic server 30 that performs data analysis on the search history database 25. The collaborative search system 10 works in conjunction with a conventional web search engine 35 such as a Google or Bing search engine. In some embodiments, the database server 20 may also maintain a knowledge database 40. Alternatively, the knowledge database 40 could be maintained by a separate knowledgebase server.

The browser utility 15 is an application that installs as a browser extension. The browser utility 15 captures search information and browsing history as customer support agents perform web searches and browse the web for solutions to technical support problems. The captured information includes search queries entered by the technical support agent, clicks on search results, timestamps for queries and clicks, and dwell times. In addition, the browser utility 15 adds a button 52 on the tool bar of the browser window that allows technical support personnel to “flag” any web pages that the technical support person finds helpful in finding a solution to a technical support problem. All data collected by the browser utility 15 is sent in real time to the database server 20.

The database server 20 maintains a search history database 25 that stores the search queries performed by customer support agents, browsing information, and addresses of recommended web pages. When a technical support agent performs a search, the browser utility 15 sends the search query to the database server 20. The database server 20 compares the received search query to previously performed searches stored in the search history database 25. If the search history database 25 contains a previous search query that is similar to the current search query entered by the technical support agent, the database server 20 outputs the web address (e.g. URL) any recommended web pages associated with the similar search query to the browser utility 15. If multiple search queries stored in the search history database 25 match the current search query, the addresses of the recommended pages associated with all or selected ones of the similar search queries may be output. The browser utility 15 then generates a search results page that lists or highlights the recommended web pages along with the conventional search results supplied by the web search engine.

The analytics service 30 provides analytics for the searching and browsing information stored in the search history database 25. The analytics service 30 may provide information such as usage trends (e.g., aggregate number of searches performed per day), average search time, query trends (e.g., aggregate statistics for most frequent searches); most visited websites, and a list of suggested or recommended web pages with corresponding search queries. The list of recommended web pages is derived from web pages flagged by customer support agents.

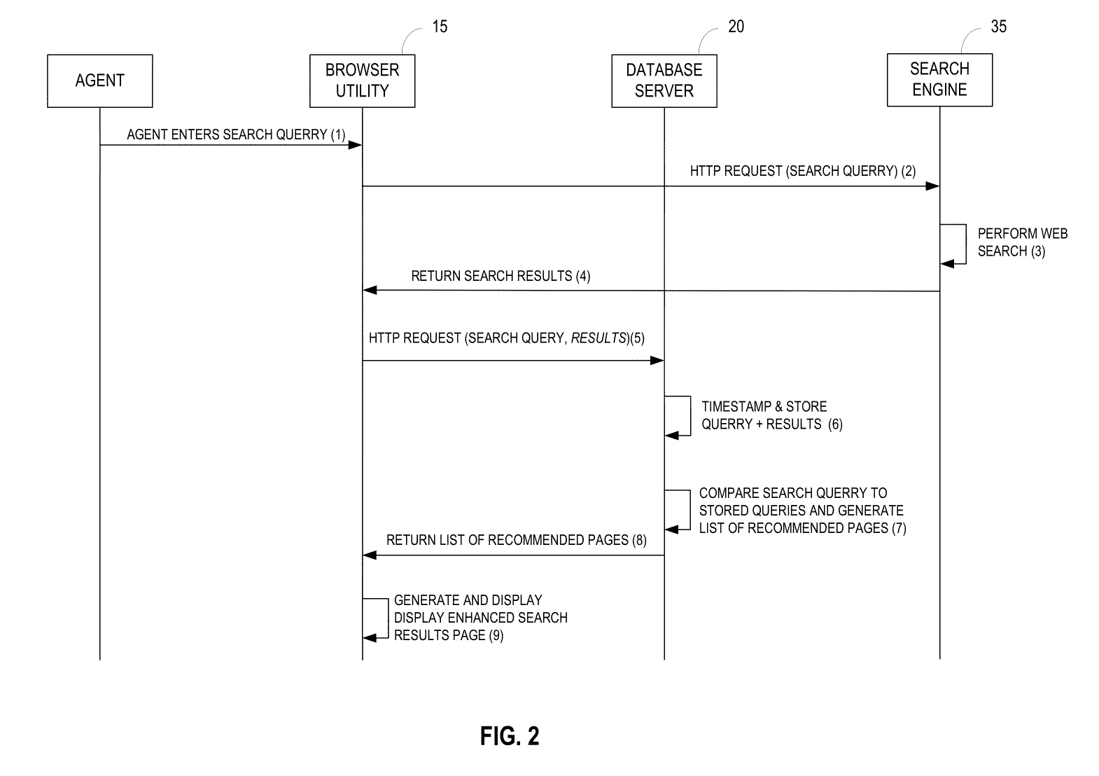

FIG. 2 illustrates a procedure for performing searches and recommending web pages according to one exemplary embodiment. When a technical support agent is unable to find a solution to a technical support problem in the knowledge base, the agent may perform a conventional web search to find a solution to the problem. The customer support agent accesses a conventional search engine 35, such as Google or Bing, and enters a search query into the search page presented by the search engine 35. The search engine 35 comprises an application running on a web server and designed to search for information on the Internet. The search engine 35 is typically accessed via a web browser and a search page associated with the search engine 25 is displayed in the browser window. The technical support agent enters a search query, referred to herein as the current search query, into the search page (step 1). When the search query is entered, the browser utility 15 forwards the forwards the search query to a conventional search engine 35 as an HTTP request (step 2). The search engine performs a search (step 3) and returns results to the browser utility 15 (step 4). The browser utility 15 sends the search query and optionally the search results to the database server 20 as an HTTP request (step 5).

The database server 20 timestamps the search query and stores the search query and timestamp in the search history database (step 6). The database server 20 compares the current search query entered by the technical support agent to previously performed search queries stored in the search history database 25 and generates a list of recommended pages (step 7). The recommended pages comprise web pages previously “flagged” or recommended by other customer support agents using the collaborative search system 10. The recommended web pages may be identified, for example, by a uniform resource locator (URL), IP address, or other identifer. The database server 20 then returns the list of recommended pages to the browser utility 15 (step 8). Upon receipt of the recommendations from the database server 20, the browser utility 15 generates and displays an enhanced search results page including the search results returned by the search engine 25 (step 9). The enhanced search results page also lists or highlights the recommended pages returned by the database server.

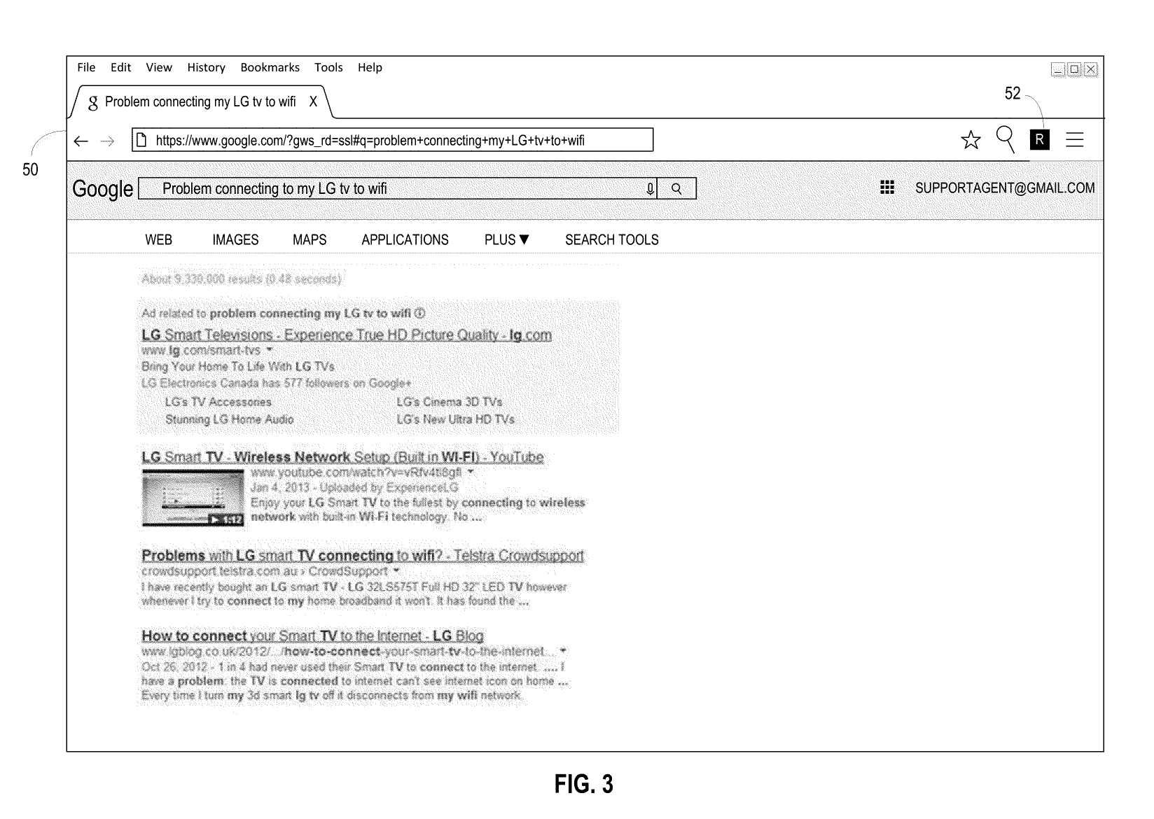

FIG. 3 illustrates a conventional search results page generated by a conventional web browser and displayed in a browser window 50. The search results page comprises a list of web pages which is generated and returned by the search engine 25. The web pages are ranked according to an algorithm executed by the search engine 25. However, most search engines 25 are not designed to surface solutions to technical support problems. Rather, rankings are usually based on the linking structure of the web pages, which does not necessarily produce the most relevant results. Therefore, a technical support agent must spend a lot of time reviewing and filtering the search results to find web pages that provide a solution to a particular technical support problem. The efforts of the technical support agent may subsequently be duplicated by other customer support agents presented with the same technical support problem.

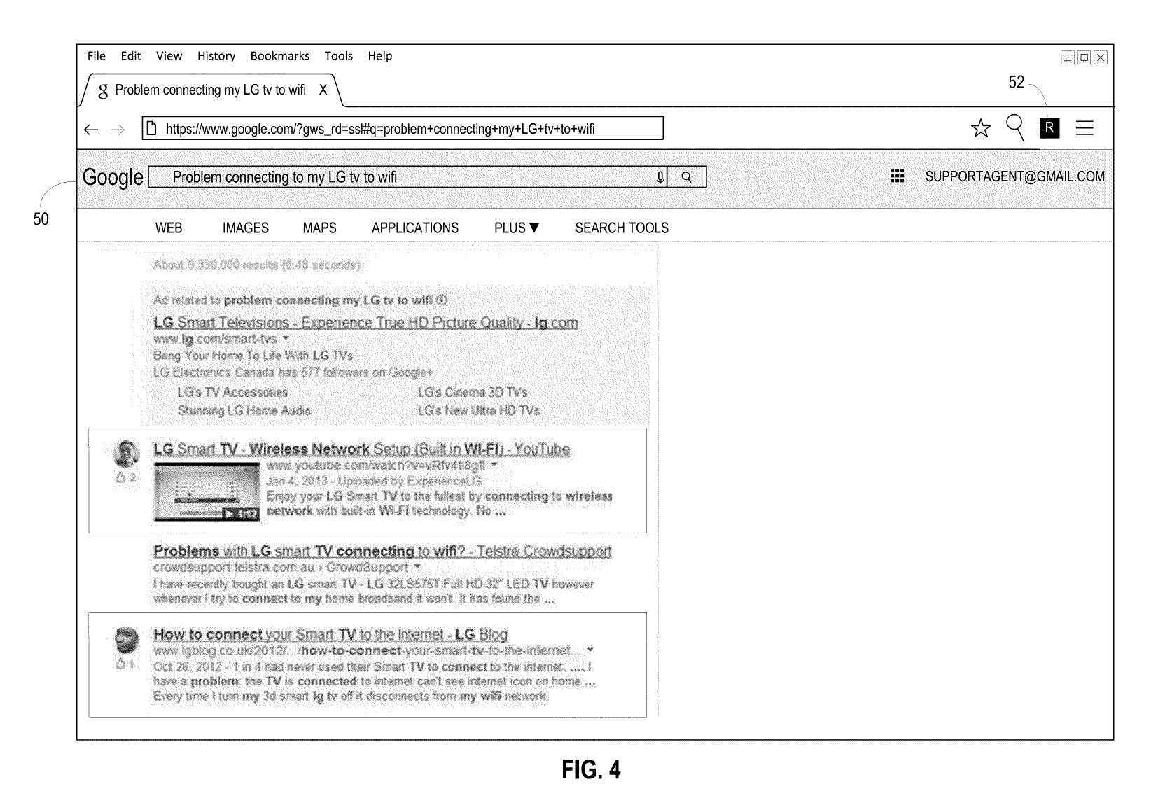

FIG. 4 illustrates an enhanced search results page generated using results returned by the search history database 25. As previously described, the results returned by the database server 20 are combined with the search results returned by the conventional search engine 25. Web pages recommended by other customer support agents using the collaborative search system 10 are highlighted in the search results page. The identity of the user recommending the page may also be presented in the search results page.

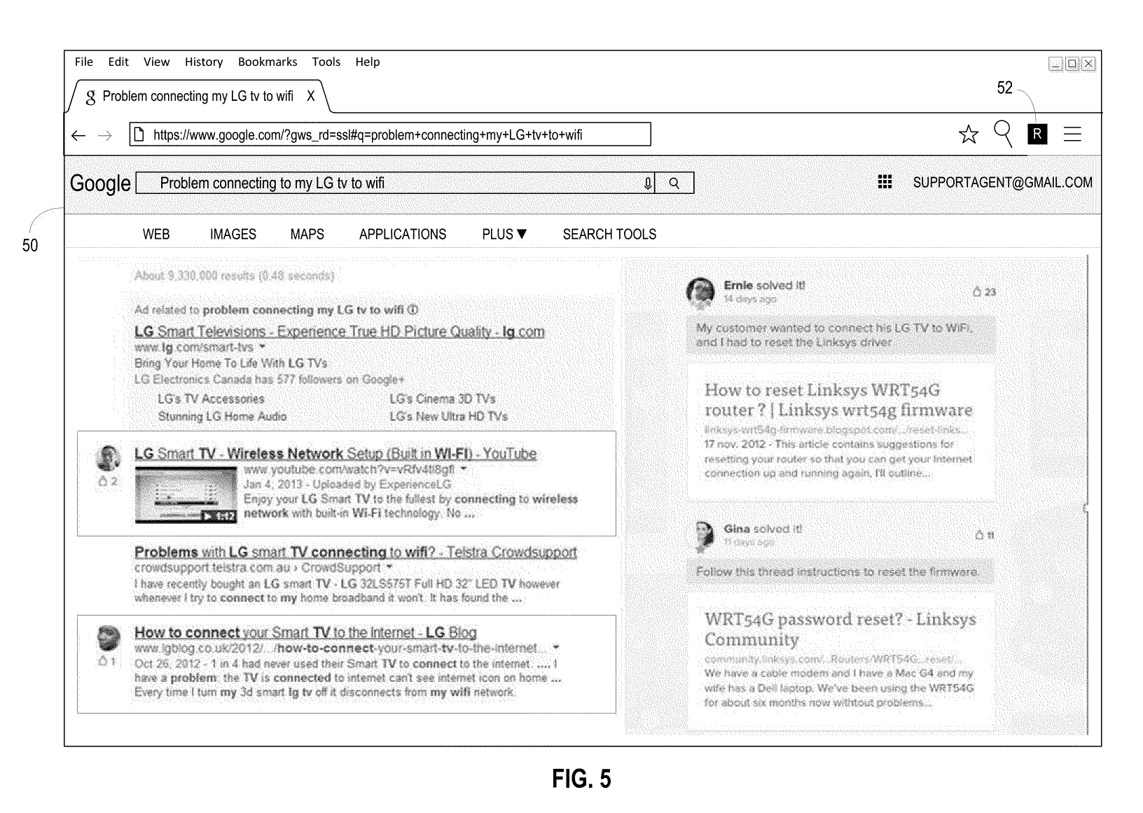

FIG. 5 illustrates another exemplary search results page with search result enhancement according to another embodiment. In this embodiment, the search results returned by the conventional search engine 25 are shown on the left side of the search results page. Web pages in the conventional search results that have been recommended by other users are highlighted. The right side of the search results page includes additional web pages that have been recommended but were not returned by the conventional search engine 25. Thus, the collaborative search system 10 enables users to locate web pages that were not returned by the conventional search engine 25 and may not have been otherwise found by the user.

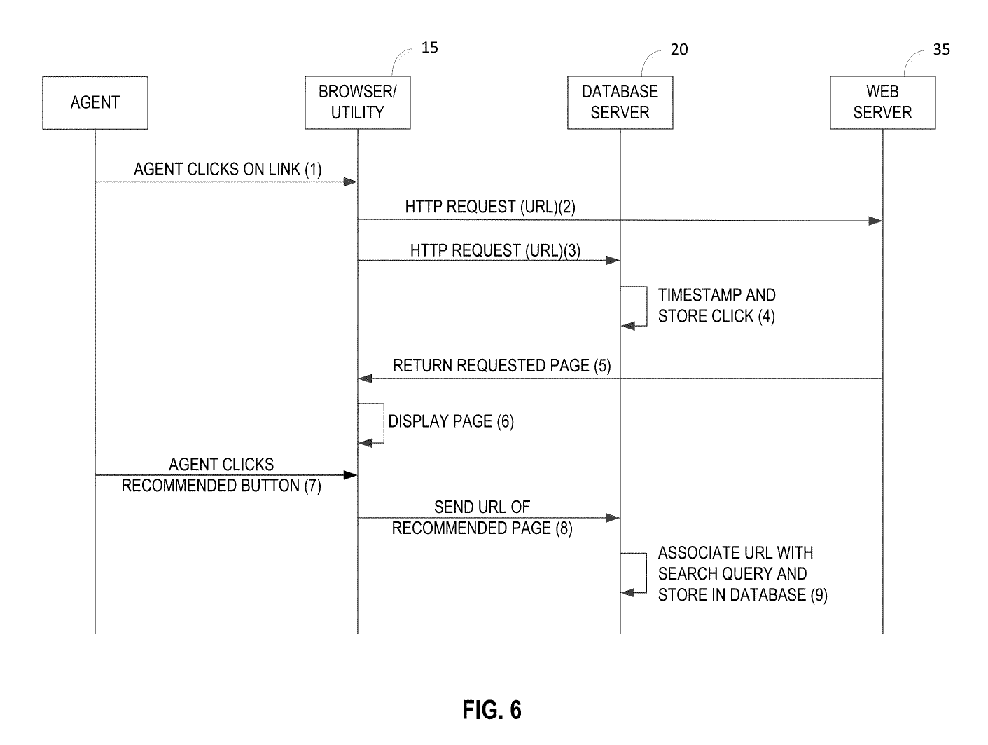

FIG. 6 illustrates an exemplary process for browsing web documents according to an exemplary embodiment. Generally, browsing is the process of following hyperlinks between web pages. When a web page is presented in the browser window 50, the web page may include one or more hyperlinks linking to other web pages. A technical support agent searching for a solution to a technical support problem may “click” on a hyperlink in a displayed web page. When a hyperlink is “clicked”, the browser sends an HTTP request to a web server identified in the hyperlink and another web page is returned and displayed in the browser window 50.

Referring back to FIG. 6, the technical support person clicks on a hyperlink on a displayed web page to access another web page (step 1). The browser utility 15 sends a HTTP request including the URL associated with the hyperlink to a web server to retrieve the web page associated with the hyperlink (step 2). The browser utility also sends the HTTP request to the database server 20 (step 3). The database server 20 stores the URL associated with the hyperlink that was selected along with the timestamp (step 4). The web server returns the requested web page (step 5). Upon receipt of the web page, the web page is displayed in the browser window 50 (step 6). Steps 1-6 may be repeated as the technical support agent browses the web.

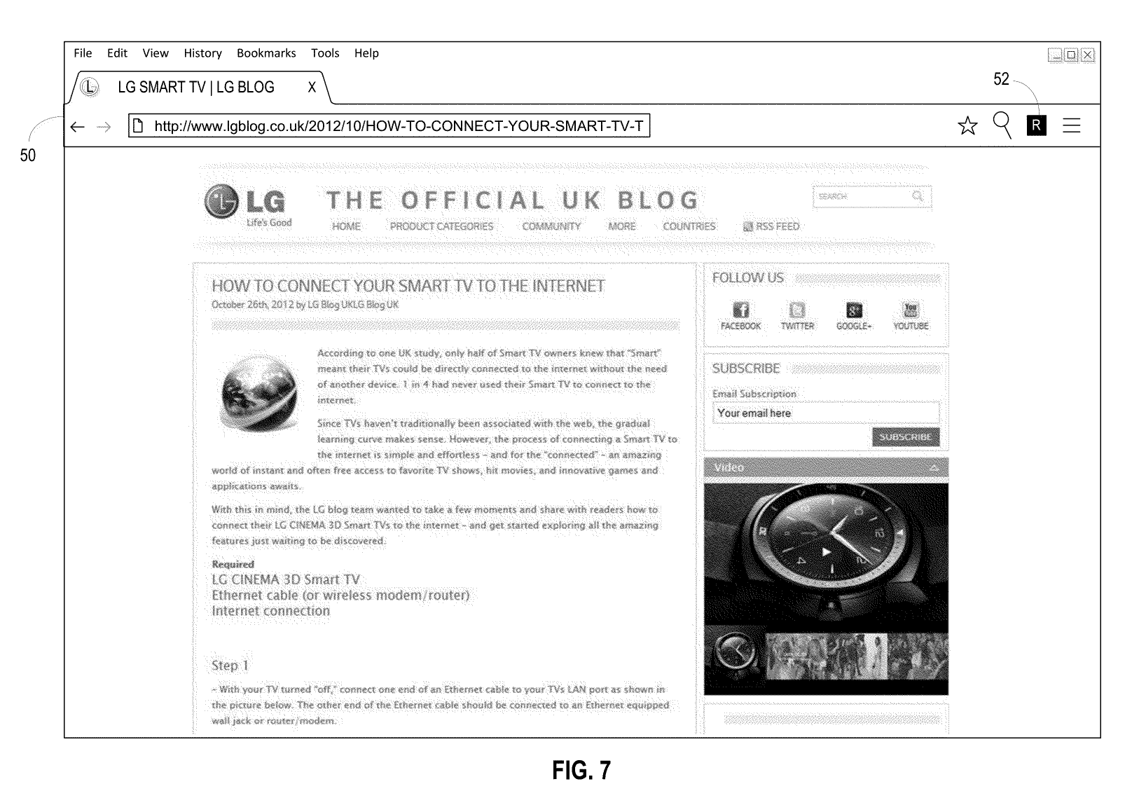

The browser utility 15 installs a recommend button 52 that is displayed on the menu bar of the browser window 50. See, FIG. 7. When a web page is displayed in the browser window 50, the technical support agent may recommend the web page by selecting the “recommend” button 52 (step 7). In response to the selection of the recommend button 52 by the technical support person, the browser utility 15 sends the URL of the recommended page to the database server 20 (step 8). The database server 20 associates the URL of the recommended page with the last search query executed by the technical support agent and stores the URL of the recommended page in the search history database 25 (step 9). Those skilled in the art will appreciate that a user may browse through multiple web pages before reaching the recommended web page. Thus, the recommended page may comprise a web page that was not returned with the search results for the search query.

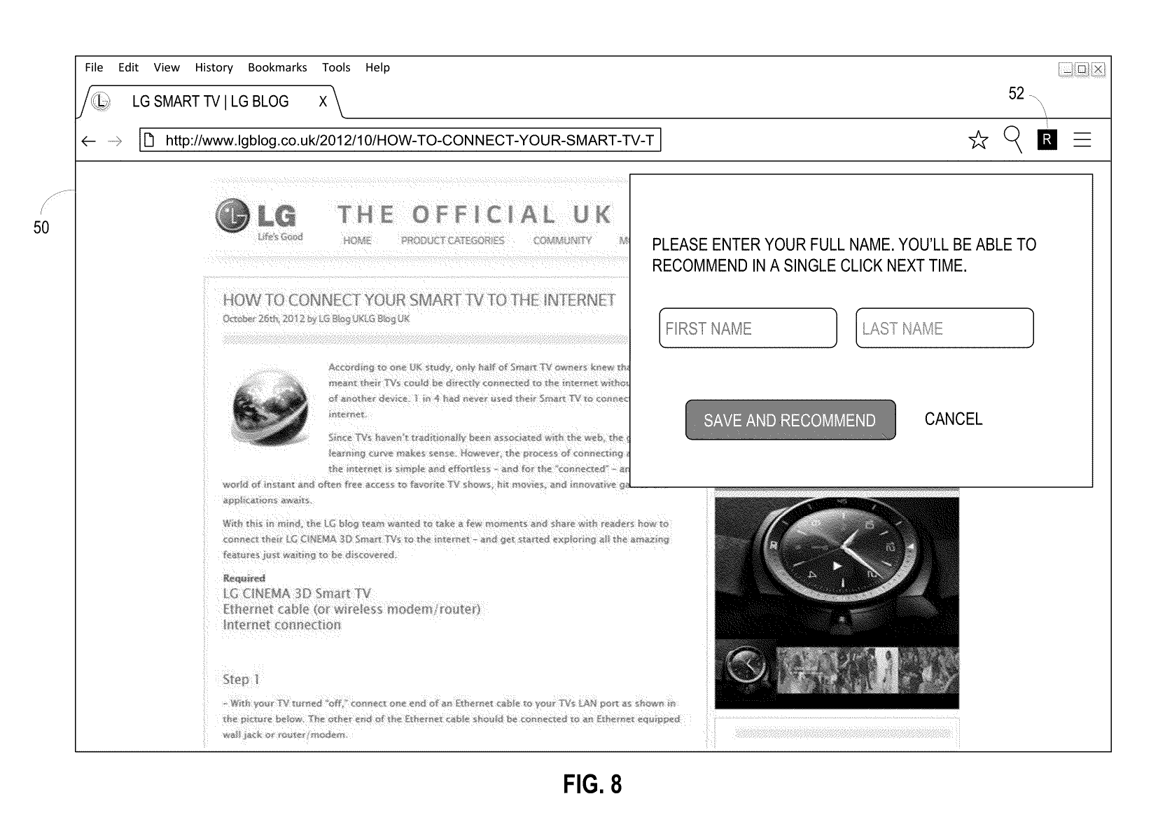

In some embodiments, the browser utility 15 may display a dialog box for entering the user's name when the recommend button 52 is clicked. See, FIG. 8. In one exemplary embodiment, the dialog box is presented the first time that the user recommends a page and is not thereafter presented. The user identity of the technical support agent may be stored in the search history database 25 and displayed in the enhanced search results page

In one embodiment, query clusters are used to simplify the search for similar queries in the search history database. There are many known techniques for clustering queries and the particular clustering technique used is not a material aspect of the invention. In general, a query cluster is formed by a group of similar search queries representing the same or similar information need. Once the query clusters are formed. the current search query can be compared to the query clusters rather than to individual search queries stored in the search history database to determine the set of previous search queries that are most similar to the current search query. However similarity is determined, the recommended URLs associated with the query cluster having the most similar results may be output to the browser utility 15.

In one exemplary embodiment, the collaborative search system uses hierarchical clustering technique (divisive or agglomerative) based on edge betweeness centrality for clustering queries. To briefly summarize, a high-connected graph is constructed based on information in the search history database. The graph includes four data node types: 1) query nodes; 2) result URL nodes; 3) clicked URL nodes; and 4) recommended URL nodes. The query nodes represent the search queries entered by the customer support agents. The result URL nodes represent the results returned by the search engine for a specific query. The clicked URL nodes represent the web pages visited by the customer support agent during a search. The recommended URL nodes represent the web pages that are recommended by the customer support agent. The query nodes are connected by edges to the corresponding result URL nodes, clicked URL nodes and recommended URL nodes. Assuming that all nodes are connected, the graph represents one data set comprising all searches.

In order to generate the query clusters, a divisive hierarchical technique may be used in which the graph representing the entire data set is recursively split into smaller data sets or clusters until a termination criteria is met. At each step, the clustering function selects a cluster, computes the edge betweeness centrality for all edges within the cluster, and removes the edge with the maximum betweeness centrality. This process is repeated for all clusters so formed until the clusters have no edges with a betweeness centrality greater than a threshold. Alternatively, an agglomerative hierarchical technique may be used to generate the query clusters in which the clustering function begins with a single node and builds a cluster until a termination criterion is met.

When a new search is performed, the search results returned by the web search engine 25 are provided to the database server 20. The database server compares the search results returned by the web search engine 25 with result URLs in each query cluster and determines the query cluster having the most results in common with the search results returned by the web search engine 25. The recommended URLs for the query cluster having the most similar results is output to the browser utility 15. The current search query is then assigned to the selected query cluster and stored in the search history database.

Distance-based clustering techniques based on keyword similarity may also be used to generate the query clusters. In one distance-based clustering technique, search queries are represented as points in a multidimensional space, where each axis of the multidimensional space represents a word or character. Similar search queries will be close in distance while dissimilar search queries will be far apart. The query clusters will appear as a cloud of points in close proximity. Query clusters are thus determined by computing the distance between search queries and grouping queries within a predetermined distance to each other, or to a common point.

Distance metrics, such as the well-known Levenschtein distance, may be used to determine the similarity or closeness of the search queries. The Levenschtein distance between two queries is the minimum number of single character edits, such as insertions, deletions or substitutions, required to convert one query to another. The Levenschtein distance belongs to a larger class of distance metrics known as edit distances. In one embodiment, queries that are determined to be within a predetermined distance from each other, or to a common point, using Levenschtein distances may be grouped to form a query cluster.

Each query cluster so formed can be represented by a centroid that is similar in form to the search queries within the query cluster. When a new search is performed, the current search query being executed is compared to the centroid of each query cluster. Levenschtein distance may also be used for determining the similarity between a current search query and the centroid of a query cluster. If the distance threshold is met, the database server 20 outputs the recommended web pages associated with any queries in the cluster. The current search query is then assigned to the query cluster and stored in the search history database. The centroid of the query cluster is then recomputed.

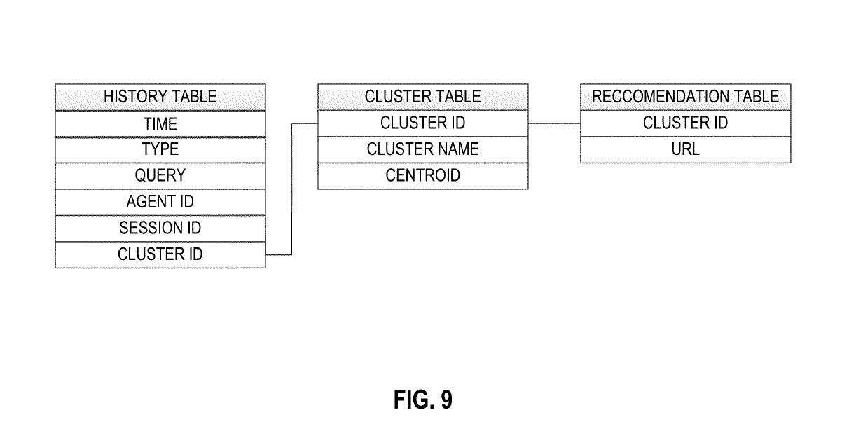

FIG. 9 illustrates the structure of an exemplary search history database. In the embodiment shown in FIG. 9, the database comprises a history table, a cluster table, and a recommendation table. The history table stores the search and browsing history of the customer support agents. Search queries performed by the customer support agents are stored in the history table, along with the URL of websites visited by the customer support agents. As previously noted, the search queries stored in the history table are assigned to query clusters, i.e. a group of queries representing the same or similar information need. The cluster table stores the cluster ID, cluster name, and optionally the centroid of each query cluster. The recommendation table stores web pages that have been recommended by users and associates each recommendation with a corresponding query cluster.

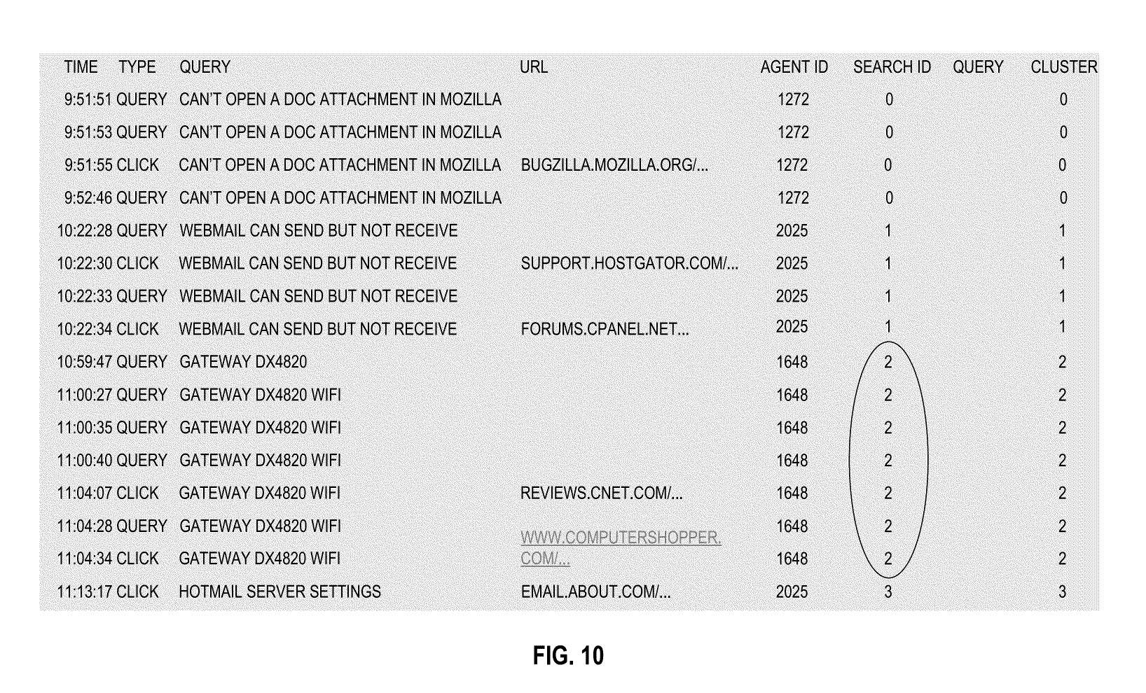

FIG. 10 illustrates an exemplary record set in the history table of the search history database. In this example, the history table includes six fields: time, type, query, URL, agent ID, session ID and cluster ID. The time field stores the time when an HTTP request is received by the database server 20 from the browser utility 15. The HTTP request may comprise a search query or request for a web page. The type field indicates the type of the HTTP request, e.g., query or click. The query field stores the search query that was entered by the technical support agent. The query field is also included in records of web pages visited by the user which are indicated by the type “click.”. The URL field stores the address of web pages visited by the technical support agent. The agent ID field stores a unique identifier associated with a technical support agent. The session ID stores a session number for a group of records in the history table. The cluster ID field stores a unique identifer for the query cluster to which a search query is assigned.

The first record in the record set shown in FIG. 10 represents a search query entered by a technical support agent (agent no. 1272). The third record in the database indicates that the agent clicked a hyperlink in the search results. The webpage referenced by the hyperlink is stored in the URL field. In one embodiment, queries and clicks that are closely spaced in time are considered to be part of the search session. In other embodiments, the identification of a search session may also involve analysis of the keywords in the search query. In general, if the queries are closely spaced in time and represent the same or similar information needs, they are considered to be part of the same search session.

The cluster table stores the cluster ID and the result URLs or centroid of each defined query cluster. Rather than search through the entire search history table to find similar queries, the database server 20 may be configured to compare the results returned by the current search query with the result URLs of each query cluster. Alternatively, the database server 20 may be configured to compare the keywords of the current search query with the centroid of each query cluster using, for example, a distance metric. If the search query is found to belong in a particular query cluster, the cluster ID is used to lookup recommended web pages in the recommendation table.

The recommendation table associates each recommendation with a cluster ID and stores the cluster ID and URL of the recommended webpage. The recommendation table may store multiple recommendations for each query cluster. If, during a search session, the technical support agent clicks on the recommend button 52 in the browser window 50, the database server 20 associates the recommended web page with a particular query cluster and stores the recommendation in the recommendation table. When a current search query is found to be similar to a particular query cluster, all recommendations associated with that query cluster will be included in the document list generated by the database server 20. Thus, all recommendations resulting from search queries belonging to the same query cluster will be included in the document list generated by the database server 20.

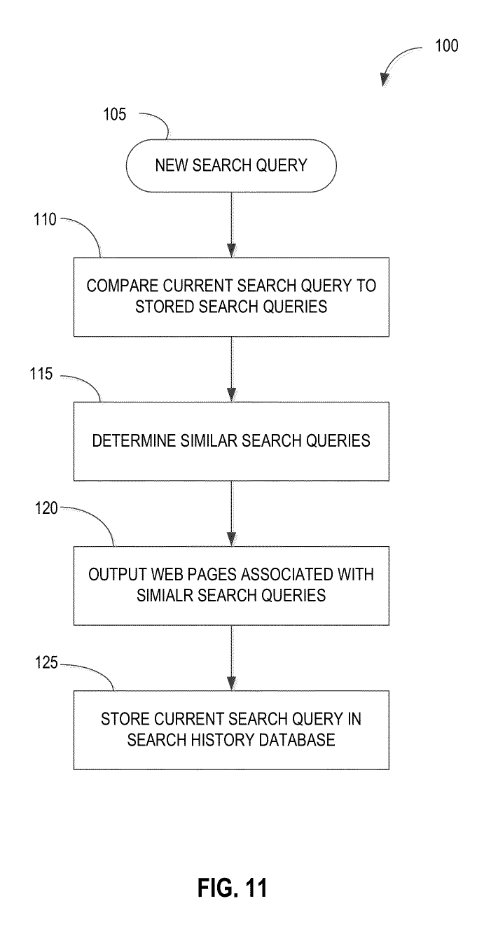

FIG. 11 illustrates a method 100 implemented by a database server 20 of comparing a current search query to the search query stored in the search history database 20. The method 100 begins when a new search query is received (block 105). When a new search query is received, the database server 20 compares the current search query to the search queries stored in the search history database and determines whether any previous search queries are similar to the current search query (block 110). As previously noted, the search queries stored in the search history database may be assigned to query clusters and the current search query may be compared to the result URLs or centroid of each query cluster to determine the similar queries. The database server 20 then generates a list of recommended web pages (block 115). As previously discussed, the recommendation list comprises web pages associated with the similar search queries. The new query is stored in the search history database and the search history database is updated to reflect the new search query (block 120). In one embodiment, the current search query is assigned to the query cluster that is determined to be most similar or to a new cluster if no existing query cluster is deemed similar. The assignment of the current search query to a pre-existing search query cluster may change the centroid of the query cluster, in which case the centroid may be recomputed following the assignment.

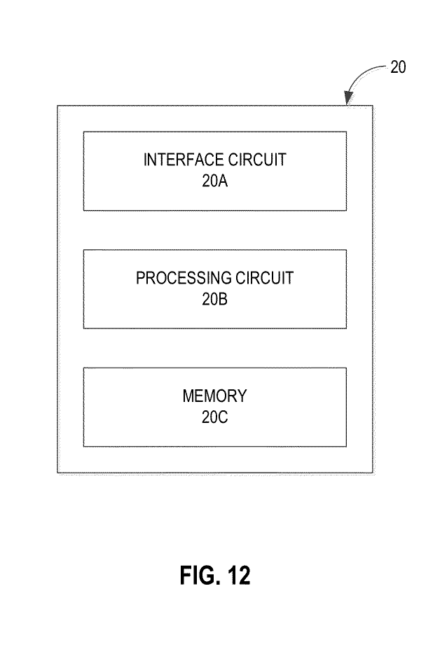

FIG. 12 illustrates an exemplary database server 20 according to one embodiment. The database server 20 comprises an interface circuit 20a, processing circuit 20b, and memory 20c. The interface circuit 20a may comprise a wireless or wired interface configured to connect the database server 20 to a communication network. For example, the interface circuit 20a may comprise transceiver circuit for connecting to a wireless network, such as a cellular network or wireless local area network (WLAN). The processing circuit 20b comprises one or more microprocessors, microcontrollers, hardware, firmware, or a combination thereof. Memory 20c may comprise both volatile and non-volatile memory for storing program instructions executed by the processing circuits 20b, as well as temporary data generated during processing.

In one embodiment database server 20 connects via internal or external bus to the knowledge database and search history database and is responsible for maintaining both. In other embodiments, the knowledge database may be maintained by a separate database server accessible via the Internet.

Although the embodiments are described in the context of a technical support solution, those skilled in the art will appreciate that the techniques described herein may be used to facilitate collaborative searching by any group of users with a common information need.

According to another aspect of the disclosure, the data analysis server 30 may analyze the data to provide useful information to knowledge base managers such as usage trends (e.g., aggregate number of searches performed per day), average search time (e.g., average time of a search session), query trends (e.g., aggregate statistics for most frequent searches), and most visited websites (list of recommended web pages with corresponding search queries). The record of search queries within the search history database also reflects the information needs of the customer support agents. Gaps within the knowledge base, referred to herein as knowledge gaps, may be ascertained by analyzing the search history database to determine the information needs.

In order to facilitate knowledge gap analysis by knowledge base managers, it is useful to generate cluster names for query clusters that accurately represent the information need represented by the query cluster. The data analysis server 30 may automatically detect and label query clusters using a domain ontology and textual templates. The query cluster names generated using the domain ontology more accurately describe the information need in language that is readily understood by the knowledge base managers.

Search engines require that an information need be expressed as a set of keywords forming a search query. The term keyword as used herein refers to a single word or phrase that describes a concept. In the field of customer support or technical support, the search queries follow a limited set of patterns. These patterns may be defined in terms of an ontology representing the knowledge domain. The ontology comprises a number of different components which may be generally labeled as entities (or individuals), classes and relations. Entities are the base components of the ontology and represent the set of things that the ontology describes. Classes represent a group of entities that share common characteristics or attributes. Relations represent the way entities or classes relate to one another.

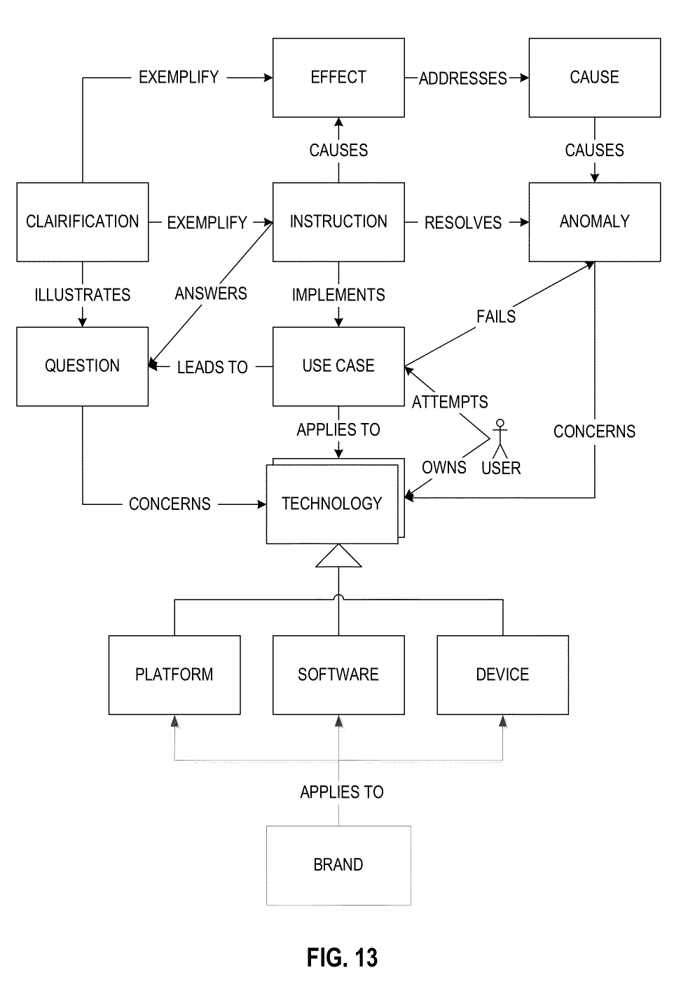

FIG. 13 is a simplified technical support ontology showing representative classes and relations between entities in those classes. The technical support ontology defines the following classes and relations:

TABLE 1
Technical support ontology

| Class | Class description | Example entities | Relations |
|---|---|---|---|
| Technology | Represents technology | See Platform, | 1) Concern of Question |
| | used in computing, | Software, and Device | 2) Concern of Anomoly |
| | communications and | examples | |
| | entertainment. | | |
| Platform | Represents | Windows 8 | Subclass in class |
| | | Mac OSX | Technology |
| | | Linux | |
| Software | Represents | Microsoft Word, | Subclass in class |
| | | Adobe Photoshop | Technology |
| | | Apple Keynote | |
| Device | Represents devices that | Computer | Subclass in class |
| | people use in computing, | TV | Technology |
| | communication, and | Routers | |
| | entertainment | Cable modem | |
| Use Case | Represents | Printing | 1) Applies to Technology |
| | | Web browsing | 2) Produces an Anomaly |
| | | Video recording | 3) Leads to Question |
| | | | 4) Implemented by |
| | | | Instruction |
| Instruction | Represents instructions | “Press Ctrl, Alt, Delete | 1) Implements Use Case |
| | on how to use | keys at the same | 2) Resolves Anomaly |
| | technology to implement | time.” | 3) Causes Effect |
| | use cases, to resolve | | 4) Exemplified by |
| | anomalies, or to cause | | Clarification |
| | effects. | | |
| Anomaly | Represents problems | Poor image quality | 1) Caused by Cause |
| | encountered in the use | No sound | 2) Resolved by Instruction |
| | of a technology | | 3) Concerns a Technology |
| Cause | Represents causes of | The wifi printer does | 1) Causes Anomalies |
| | anomalies | not show up in the list | 2) Addressed by Effect |
| | | of available printers | |
| | | because wifi is | |
| | | disabled | |
| Effect | Description of the | After you press the | 1) Addresses Cause of |
| | resulting state of the | “reset” button for 5 | Anomaly |
| | system after an | seconds you should | 2) Exemplified by |
| | instruction is performed. | hear a long beep. | Clarification |
| Clarification | A free form text that | “You may find the | 1) Exemplifies Effect |
| | provides more | reset button on the | 2) Exemplifies Instruction |
| | information about a | button of the device.” | 3) Illustrates Questions |
| | specific concept | | |
| Question | Represents questions | Is the light indicator | 1) Concerns Technology |
| | concerning a technology | on your Apple Time | 2) Result of Use Case |
| | | Capsule green or | 3) Illustrated by Clarification |
| | | orange? Is it blinking? | |
| Brand | Represents brand of a | HP | 1) Applies to a device, |
| | device | Samsung | software or platform |
| | | DLink | |

Using the domain ontology, a set of templates may be defined that describe the typical patterns followed by search queries. Each pattern comprises a set of components, shown in brackets, that corresponds to a class defined by the ontology. Table 2 below illustrates exemplary templates based on the technical support ontology shown in FIG. 13. The templates may be pre-defined by a knowledge base manager or machine generated. Cluster names are generated by mapping the most relevant keywords to corresponding components in a selected one of the naming templates.

TABLE 2
Exemplary templates for cluster naming

| Template | Example Cluster name |
|---|---|
| {brand} {device} {use case} | Dlink router get default login |
| {software} {anomaly} on {device} | Netflix not loading on apple tv |
| {software} {anomaly} on {brand} | Netflix not playing on lg tv |
| {device} | |
| {anomaly} on {platform} | Audio problems on Windows 7 |
| {use case} {software} {device} | Synchronize iphone outlook |
| How to {use case}{brand} {device} | How to install hp wireless printer |

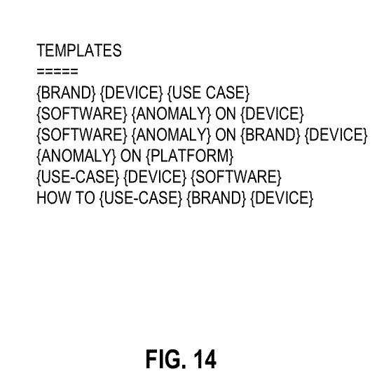

FIG. 14 illustrates an exemplary process 100 for naming a query cluster. The process may be performed by a computing device that is specially programmed for naming query cluster. The process starts by inputting a query cluster into the computing device (step 105) To generate the name of the query cluster, the natural language processing is used to select the most relevant keywords in the search queries of a query cluster (step 110). The keywords may comprise a single word or phrase that describes a concept. For example, the phrase “get default login” is a keyword describing a particular use case. Different search queries in the query cluster may use different keywords having the same semantic meaning, i.e., describing the same concept. Where different keywords have the same semantic meaning, the most frequently used one of those keywords may be selected and used for cluster naming. Once the most relevant keywords are identified, a naming template is selected from a pre-defined set of naming templates based on the selected keywords (step 115). In one embodiment, the naming template is selected by identifying the ontological class of each keyword and selecting, based on the ontological class of each keyword, a naming template having components corresponding to each of the keywords. The keywords are input to the selected template to generate the cluster name (step 120). The template arranges and formats the selected keywords into a short, easily understood description that accurately describes the information need represented by the query cluster.

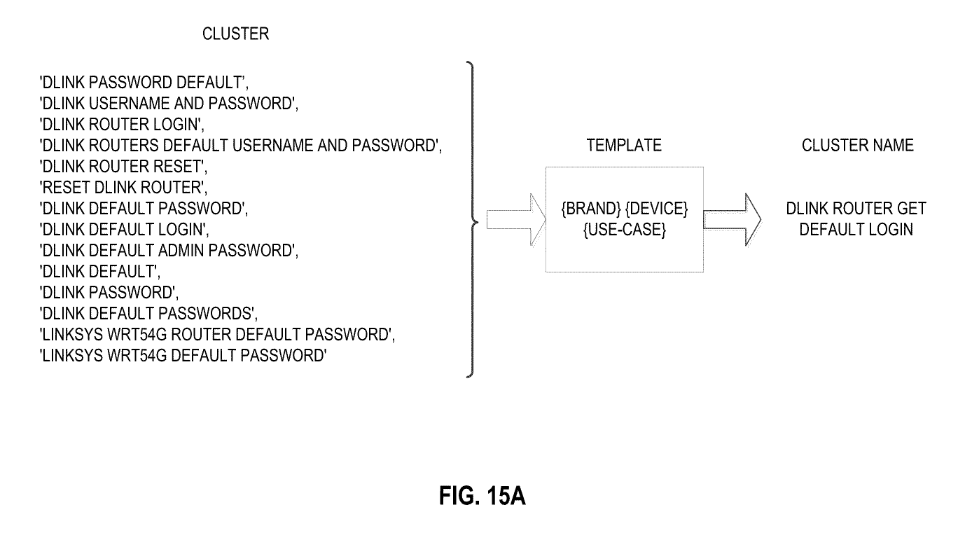

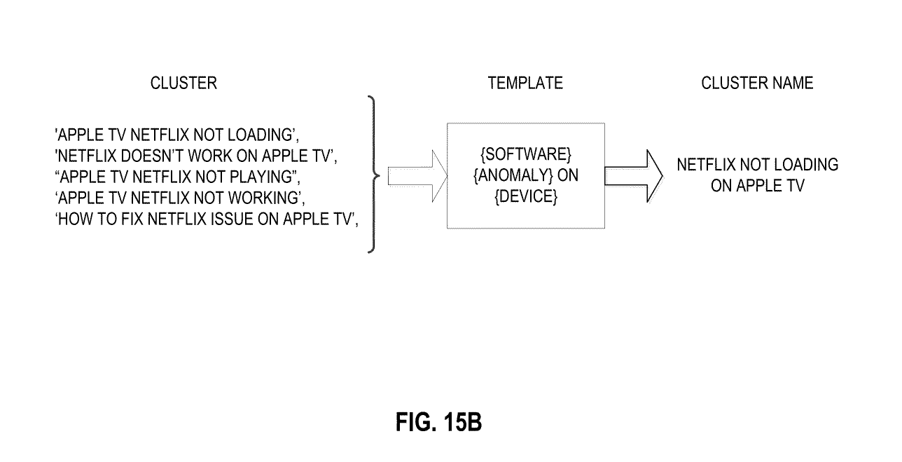

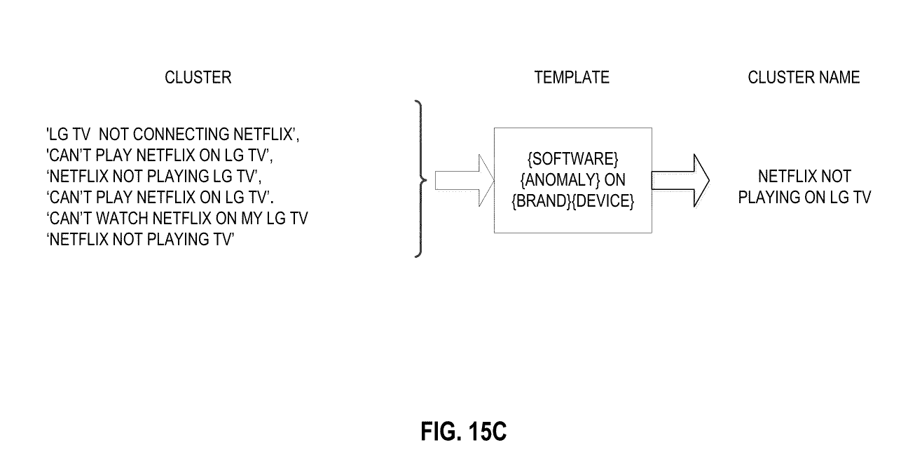

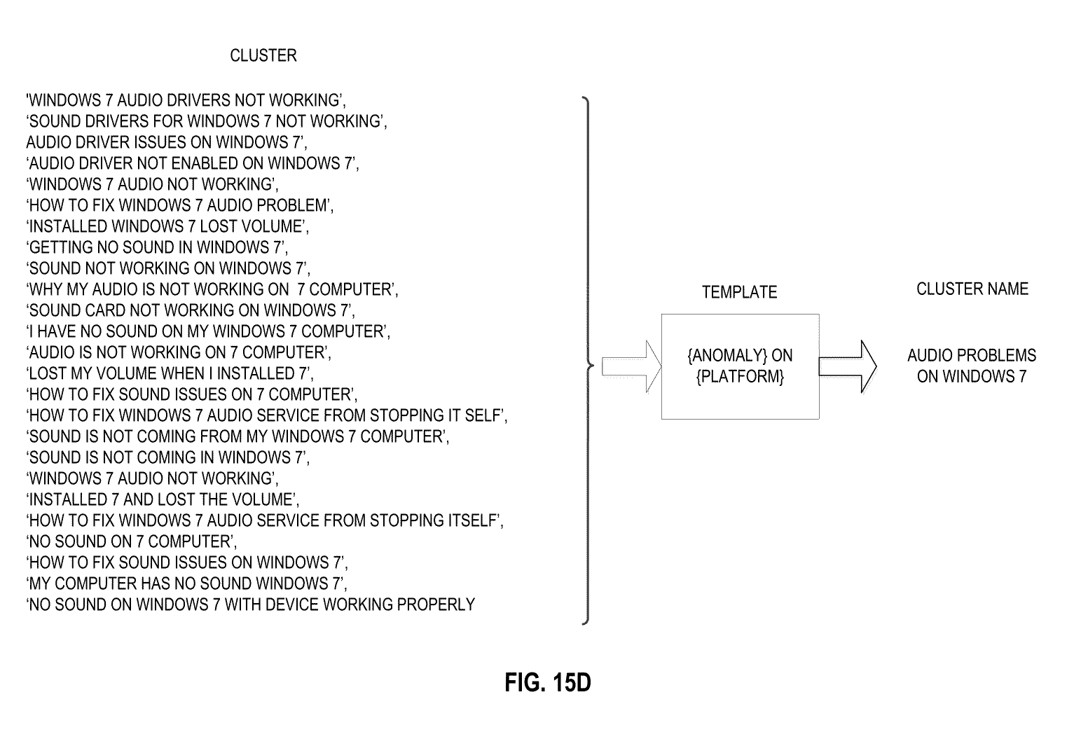

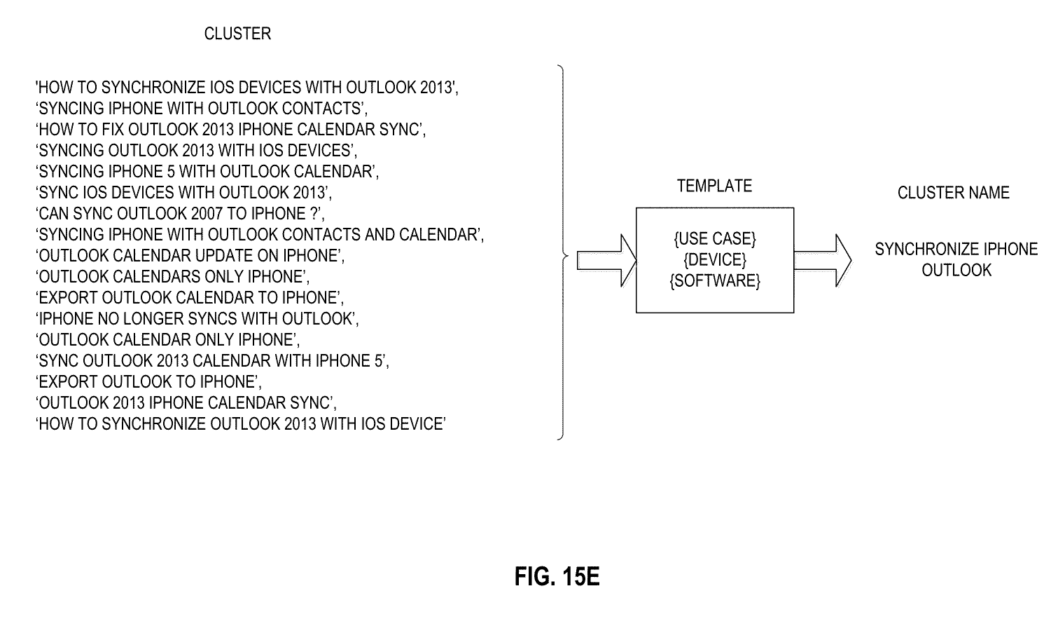

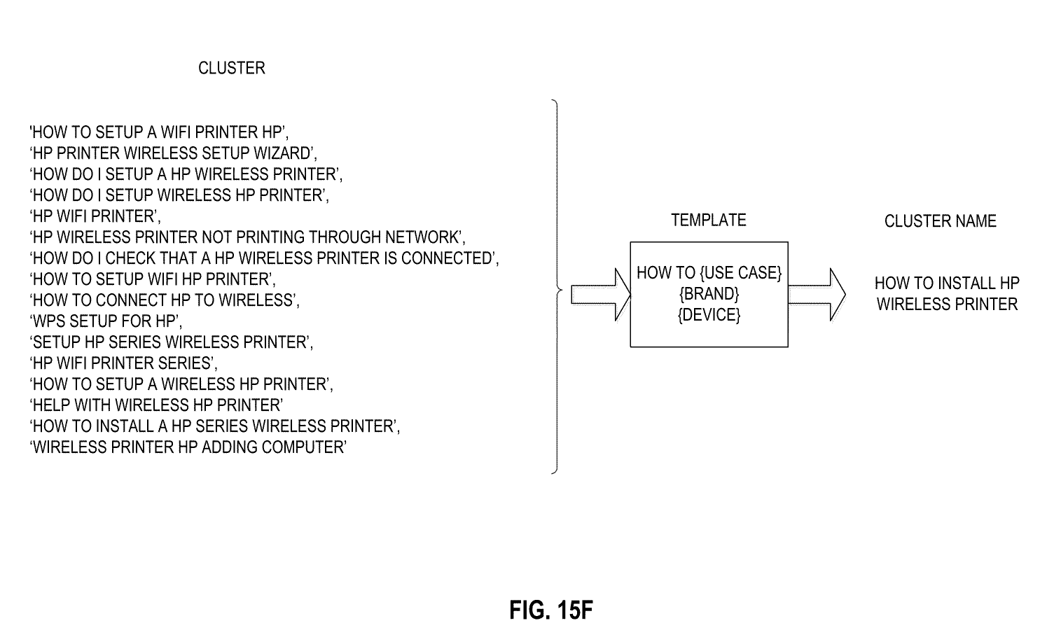

FIGS. 15A through 15F illustrate the naming of query clusters. In the example shown in FIG. 15A, the search queries in the query cluster are shown on the left. The terms “dlink,” “router” and “get default login” are selected as the most relevant keywords. The computing device recognizes that the term “dlink” corresponds to the class Brand, the term “router” corresponds to the class Device, and the phrase “get default login” represents corresponds to the class Use Case. The computing device then selects a template having components with these same class types and uses the selected template to format and arrange the keywords into an intelligible cluster name.

As shown by the examples in FIG. 15A through 15F, the resulting cluster names accurately represent the information need represented by a query cluster in a way that is readily understood by the knowledge manager. To use this information to identify knowledge gaps, the analytic engine 30 may, for example, generate a knowledge gap report identifying the most frequently used search queries and corresponding query clusters. The cluster names of the knowledge gap report may be used to identify topics for additional knowledge base articles.

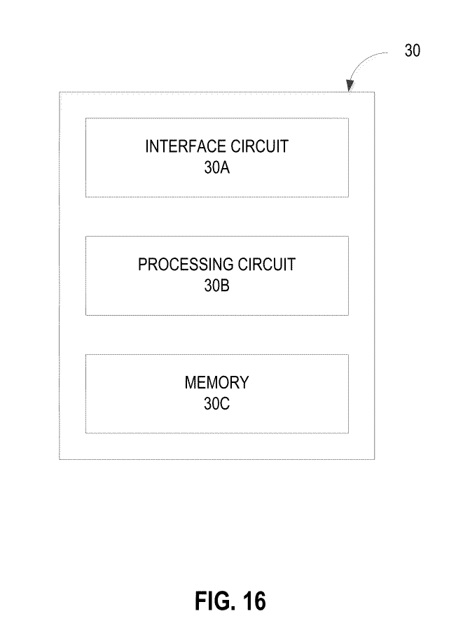

FIG. 16 illustrates an exemplary data analysis server 30 according to one embodiment. The data analysis server 30 comprises an interface circuit 30a, processing circuit 30b, and memory 30c. The interface circuit 30a may comprise a wireless or wired interface configured to connect the data analysis server 30 to a communication network. For example, the interface circuit 30a may comprise transceiver circuit for connecting to a wireless network, such as a cellular network or wireless local area network (WLAN). The data analysis server 30 may communicate via the interface circuit 30a with the database server 20. The processing circuit 30b comprises one or more microprocessors, microcontrollers, hardware, firmware, or a combination thereof. Memory 30c may comprise both volatile and non-volatile memory for storing program instructions executed by the processing circuits 30b, as well as temporary data generated during processing. Memory 30c also stores the pre-defined patterns and templates use for cluster naming.

According to another aspect of the disclosure, patterns or templates defined based on the domain ontology may also be used for search query expansion. Frequently, search queries entered by customer support agents fail to fully describe the information need. Where the information need is not fully specified, the keywords entered by the customer support agent may be compared to a predefined set of query patterns. These query patterns, similar to the naming templates described above, comprises components that correspond to different ontological classes. If the search query fails to fully describe the information need, the query expansion function may identify a set of candidate patterns based the keywords in the search query and prompt the user to either enter additional keywords corresponding to the class of the missing component or to select from a set of candidate queries that more fully describe the information need.

For example, assume that the information needs represented by search queries fall into one of the following information need patterns shown in Table 3 below, which may be pre-defined by a knowledge base manager or machine generated.

TABLE 3
Exemplary patterns for query expansion

| Information Need Pattern | Example query |
|---|---|
| resolution for [Anomaly] with | “Firefox shows a blank page on |
| [Software] running on [Platform] | Windows 7 running on Toshiba |
| and [Device] | laptop” |
| resolution for [Anomaly] with a | “Links to Evernote notes in |
| combination of [Software] and | Asana tasks don't open” |
| [Software] | |
| resolution for [Anomaly] in the | “Cannot unlock on iPhone” |
| context of [Use case] of [Device] | |
| instructions for a [Use case] with | “How to print pictures in iPhoto |
| [Software] on [Platform] on [Device] | on Mac OS X 10.6 on Macbook |
| | Air” |
| instructions for a [Use case] with | “Upgrade Nexus 7 to latest |
| [Software] on [Platform] on [Device] | Android OS” |
| instructions for a [Use case] with | “How to replace a SIM card on |
| [Software] on [Platform] on [Device] | HTC One” |

If customer support agent enters the search query “Firefox for Windows 7 shows a blank page.” The search terms “Firefox”, “Windows 7” and “blank page” are recognized as entities in the classes Software, Platform and Anomaly respectively. The software selects candidate patterns that include components corresponding to these three classes. For the example query, the first query pattern in Table 3 is selected because it includes components corresponding to each of the three specified keywords. The candidate search pattern includes an additional component corresponding to the class Device. The original query does not specify an entity in the class Device. Therefore, query expansion is performed to generate a new query including the original three keywords and an additional keyword to specify a device. In one embodiment, the query expansion function prompts the user to enter a search term corresponding to the class Device. The prompt may, for example, read “Enter type of device.” In this case, the user inputs a keyword in the class Device to complete the query. In some cases, the user may be prompted to enter multiple keywords to complete the query. In another embodiment, query expansion function may present a list of suggested queries to the user where each suggested query includes the original search terms and an additional search term in the class Device. The list of suggested queries may, for example, be: “Firefox shows a blank page on Windows 7 running on Toshiba laptop” “Firefox shows a blank page on Windows 7 running on Dell computer” “Firefox shows a blank page on Windows 7 running on HP laptop

The suggested queries may be ranked according to frequency of usage or other criteria. The user then selects a query from the list of suggested queries.

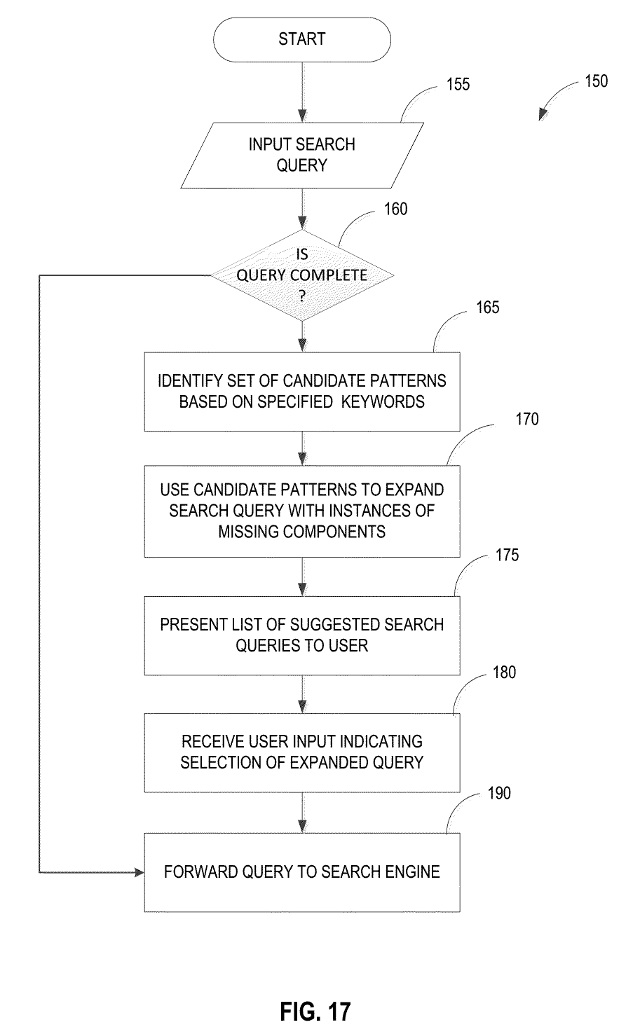

FIG. 17 illustrates an exemplary process 150 implemented by a query expansion processor. The query expansion processor comprises processing circuits and associated memory for performing the query expansion as herein described. The processing circuit may comprise one or more microprocessors, hardware, firmware or a combination thereof. The function of the query expansion processor may be performed by the processing circuit 20b of the database circuit, or the processing circuit 30b of the data analysis server. Alternatively, the query expansion processor may be performed in a stand-alone server or by the search engine 35.

The process 150 begins when the knowledge base manager or other user inputs a search query (block 155). The query expansion processor processes the query to determine whether it completely specifies the information need (block 160). If so, the query expansion processor forwards the search query to a search engine 35 to be performed (block 190). If not the process continues and the query expansion processor identifies a set of one or more candidate patterns matching the keywords and structure of the entered search query (block 165). For each candidate pattern, the query expansion processor determines components that are not specified by the search query and expands the search query with instances of the missing components (block 170). For example, if a component of the class Device is not specified in one of the patterns, the query expansion processor may expand the search query by adding keywords of the class Device to the original search query to generate a list of expanded search queries. The query expansion processor outputs the list of expanded search queries to the user and prompts the user to select a search query from the list ((block 175). In some embodiments, the query expansion processor may rank the search queries according to frequency of use, relevancy, or other criteria. The query expansion processor receiveS user input indicating a selection of an expanded search query (block 180). Upon receipt of the user selection, the query expansion processor forwards the selected search query to the search engine 35 (block 190).

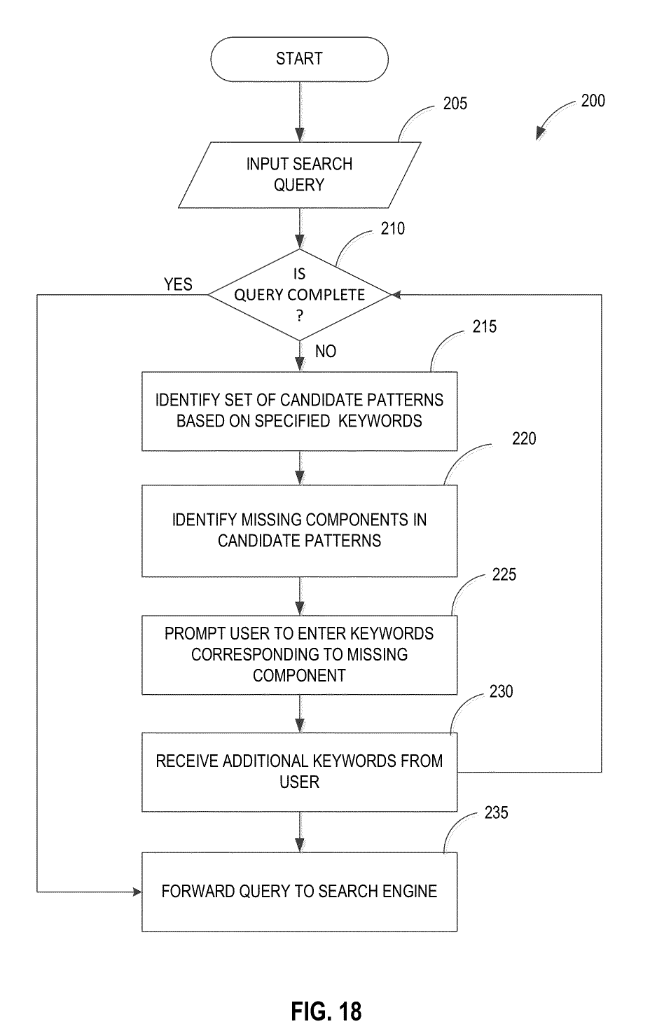

FIG. 18 illustrates another exemplary process 200 for query expansion where the user is prompted to enter keywords corresponding to missing components in the candidate patterns. The process begins when the knowledge base manager or other user inputs a search query (block 205). The query expansion processor processes the query to determine whether it completely specifies the information need (block 210). If so, the query expansion processor forwards the search query to a search engine 35 to be performed (block 240). If not the process continues and the query expansion processor identifies a set of one or more candidate patterns matching the keywords and structure of the entered search query (block 215). For each candidate pattern, the query expansion processor determines components that are not specified by the search query (block 220). The query expansion processor then prompts the user to enter additional keywords corresponding to the missing components (225). For example, if a component of class Device is missing in one candidate pattern and a component of class Software is missing in another candidate, the query expansion processor may prompt the user to enter a keyword for each missing component. The query expansion processor receives the additional keywords entered by the user (block 230). After receipt of the additional keywords, the query expansion processor checks whether the query is complete (block 210). If so, the query expansion processor forwards the search query to a search engine 35 to be performed (block 240). If not steps 215-230 are performed until the query is completed.

What is claimed is:

1. A method implemented by a computing device of expanding a search query comprising:
receiving a current search query from a user, said search query comprising one or more keywords;
identifying, based on said keywords in said search query, a set of candidate search query patterns;
identifying missing components in one or more of the candidate search query patterns;
expanding the search query to include keywords corresponding at least one of the missing components in one of the candidate search query patterns.

2. The method of claim 1 wherein identifying a set of candidate search query patterns comprises comparing the keywords of the search query to the components in a set of pre-defined search query patterns and selecting one or more candidate patterns based on the comparison.

3. The method of claim 2 wherein identifying missing components in one or more of the candidate search query patterns comprises identifying missing components in the candidate patterns have no corresponding keyword in the search query.

4. The method of claim 1 wherein expanding the search query comprises generating a list of expanded search queries, wherein each of the expanded search queries comprises keywords from the search query and at least one additional keyword corresponding to a missing component is one of the candidate patterns.

5. The method of claim 4 further comprising presenting the user with a list of expanded search queries and receiving user input indicating selection of one of the expanded search queries.

6. The method of claim 5 further comprising ranking the expanded search queries according to a predetermined criteria.

7. The method of claim 5 further comprising executing the expanded search query selected by the user.

8. The method of claim 1 wherein expanding the search query comprises:
prompting a user to enter at least one additional keywords corresponding to at least one of the missing components in one of the candidate patterns;
receiving user input of an additional keyword; and
generating an expanded search query using the additional keyword received from the user.

9. The method of claim 8 further comprising executing the expanded search query selected by the user.

10. A computing device for expanding a search query, said computing device comprising a processing circuit configured to:
receive a current search query from a user, said search query comprising one or more keywords;
identify, based on said keywords in said search query, a set of candidate search query patterns;
identify missing components in one or more of the candidate search query patterns;
expand the search query to include keywords corresponding at least one of the missing components in one of the candidate search query patterns.

11. The computing device of claim 10 wherein identifying a set of candidate search query patterns comprises comparing the keywords of the search query to the components in a set of pre-defined search query patterns and selecting one or more candidate patterns based on the comparison.

12. The computing device of claim 11 wherein identifying missing components in one or more of the candidate search query patterns comprises identifying missing components in the candidate patterns have no corresponding keyword in the search query.

13. The computing device of claim 10 wherein expanding the search query comprises generating a list of expanded search queries, wherein each of the expanded search queries comprises keywords from the search query and at least one additional keyword corresponding to a missing component is one of the candidate patterns.

14. The computing device of claim 13 further comprising presenting the user with a list of expanded search queries and receiving user input indicating selection of one of the expanded search queries.

15. The computing device of claim 14 further comprising ranking the expanded search queries according to a predetermined criteria.

16. The computing device of claim 14 further comprising executing the expanded search query selected by the user.

17. The computing device of claim 1 wherein expanding the search query comprises:
prompting a user to enter at least one additional keywords corresponding to at least one of the missing components in one of the candidate patterns;
receiving user input of an additional keyword; and
generating an expanded search query using the additional keyword received from the user.

18. The computing device of claim 17 further comprising executing the expanded search query selected by the user.
